(19) United States
(12) Patent Application Publication
(10) Pub. No.: US 2007/0199067 A1
(43) Pub. Date: Aug. 23, 2007

(54) Anti-detonation device and method

(75) Inventors: Joseph Patino, Pembroke Pines, FL (US); John M. Burgan, North Palm Beach, FL (US); Russell L. Simpson, Miami, FL (US)

Correspondence Address: FLEIT, KAIN, GIBBONS, GUTMAN, BONGINI;& BIANCO P.L., 551 N.W. 77TH STREET, SUITE 111, BOCA RATON, FL, 33487, US

(73) Assignee: MOTOROLA, INC., SCHAUMBURG, IL (US)

(21) Appl. No.: 11/301,615

(22) Filed: Dec. 13, 2005

(51) Int. Cl. G06F 12/14

(52) U.S. Cl. 726/16

(57) ABSTRACT

A wireless device (100) includes an electrical circuit arrangement (200) for deterring access to an electrical signal having a predictable electrical pattern. The circuit arrangement (200) includes a processor (206) for processing instructions and a controller (210) communicatively coupled to the processor (206) and able to send at least one signal along each of a plurality of signal lines from within the circuit (200). The processor (206) causes the controller (210) to sporadically introduce a signal onto each of the plurality of signal lines, where the signal is unrelated to any communication function of the wireless device and is present solely for the purpose of making the signal line unpredictable.

### BACKGROUND OF THE INVENTION

1. Field of the Invention

The present invention relates generally to cellular telephones, and more particularly relates to cellular phones that behave unpredictably so as to not be useful as detonation triggers for explosive devices.

2. Background of the Invention

Recently, terrorist activity around the world has risen to an all-time high. In some countries, terrorist-detonated bombings in heavily populated areas have become a virtually every-day occurrence. Sadly, these bombings have claimed thousands of lives and are expected to take thousands more.

In analyzing evidence from the terrorist-detonated bombs, it is obvious that the terrorists are becoming exceedingly more technologically advanced than would be expected. While many of the bombs are manually triggered by suicide bombers that sacrifice their own lives to take those of many others, many bombs are detonated remotely by wireless transmitting devices in conjunction with wireless receiving devices or through timers in devices, such as electronic alarm clocks.

Traditional wireless communication devices, such as a cellular telephone, have predictable electronic circuit behavior patterns. Specifically, cellular phones periodically check for incoming calls by briefly opening an input channel and listening for an airborne signal that is coded to identify that particular phone. If the phone receives a signal that it interprets as an incoming call, the phone responds to that signal in some predetermined manner. The response is either set by the manufacturer of the device or configured by a user. Such responses include an audible alert, a visual alert, a vibrating alert, handling of the incoming call by a voice mail system, recording of the incoming call in a memory, a combination of these, and others.

Because these wireless devices respond in a predicable manner, a detonation method that seems to be gaining popularity is attaching a bomb's ignition mechanism to a wireless device, such as a cellular telephone. To detonate the bomb, a terrorist need only to place a call to the phone's unique telephone number. One example of this detonation method is for a terrorist to configure the phone so that if an earpiece is attached to the phone, the earpiece will produce an audible alert at its speaker portion. The bomb's ignition mechanism can then be plugged directly into the earpiece jack on the phone's body, as if it were an earpiece. Once the bomb is in its planned location, a call to the phone will send a signal having a particular voltage to the earpiece jack, thereby also triggering the ignition mechanism.

Phones that send signals only when receiving calls and that behave in predicable patterns provide tools that too easily facilitate terrorist activities. Therefore a need exists to overcome the problems with the prior art as discussed above.

### SUMMARY OF THE INVENTION

Briefly, in accordance with the present invention, disclosed is an electrical circuit arrangement for deterring access to an electrical signal that exhibits a predictable electrical pattern. In an embodiment of the present invention, the circuit arrangement includes an electronic circuit within a wireless device, where the electronic circuit includes a plurality of signal lines. The circuit also includes a processor for processing instructions and a controller coupled to the processor. The processor causes the controller to sporadically introduce a signal onto each of the plurality of signal lines, the signal being unrelated to any communication function or timed event of the wireless device.

In an embodiment of the present invention the circuit arrangement includes a timer coupled to the processor, the timer providing a clock pulse to the processor for determining a timing for causing the controller to introduce the signal onto each of the plurality of signal lines.

In embodiments of the present invention, the processor causes the controller to sporadically introduce the signal randomly, occasionally, singly, and in scattered instances introducing the signal onto each of the plurality of signal lines.

In one embodiment of the present invention, a communication or timed event function includes at least one of receiving a call, receiving a message, notification of a scheduled event, providing a character or graphic on the display, and providing a notification of a timed event.

In another embodiment, the present invention includes a method for deterring access to an electrical signal of a wireless device having a predictable electrical pattern. The method includes energizing an electrical circuit within a wireless device, the circuit having at least one electrical pathway that is electrically accessible and having a varying electrical signal that varies over time in a pattern that is unpredictable external to the electrical circuit.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an isometric diagram illustrating one embodiment of a wireless device in accordance with the present invention.

FIG. 2 is a hardware block diagram illustrating one embodiment of a wireless device in accordance with the present invention.

FIG. 3 is a flow diagram illustrating an exemplary operation of the wireless device of FIG. 2, in accordance with the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one, or more than one. The term “plurality”, as used herein, is defined as two, or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The terms “program”, “computer program”, “software application”, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

The present invention, according to an embodiment, overcomes problems with the prior art by providing a wireless device that randomly and/or periodically pulses all signal lines so that the device cannot be used to predictably trigger an event.

Described now is an exemplary hardware platform according to an exemplary embodiment of the present invention.

Wireless Device

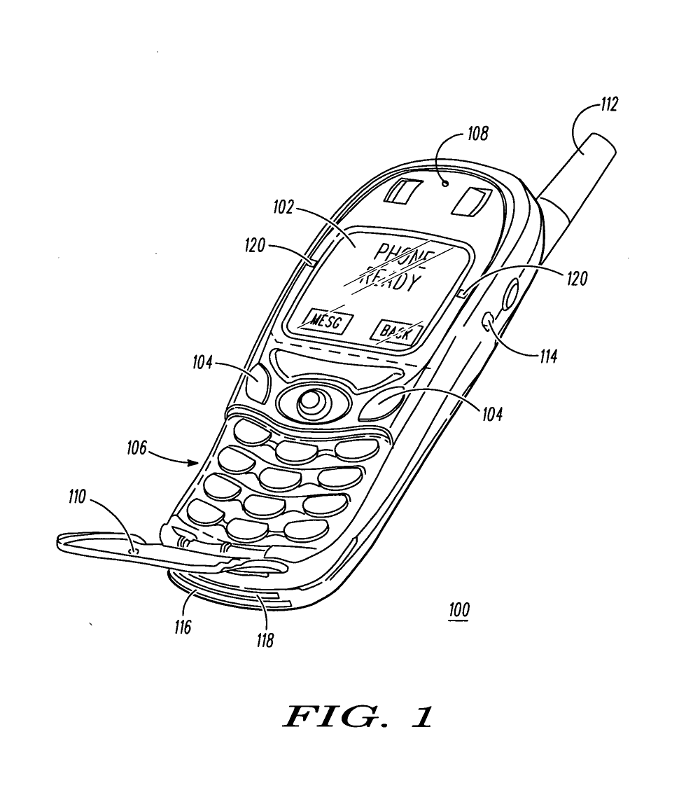

Referring now to FIG. 1, an exemplary wireless device 100 is shown. The specific wireless device 100 depicted in FIG. 1 is a cellular telephone. As will be clear however, the present invention is not so limited and can also be other wireless devices and non-wireless devices that are triggered by an electrical event, such as wirelessly receiving a signal.

Wireless devices include, but are not limited to, PDA's, SmartPhones, Laptops, Pagers, Two-way Radios, satellite phones, and other communication devices. In one embodiment of the present invention, the wireless device 100 is capable of receiving and transmitting radio frequency signals over a communication channel under a communications protocol such as CDMA, FDMA, TDMA, GPRS, and GSM or the like. For clarity and ease of discussion a wireless telephone, its structures, and functions will be referred to throughout the remainder of the specification.

A cellular telephone 100 includes a display 102 for viewing information and commands, command buttons 104 for controlling modes and commands of the device, buttons 106 for entering information and dialing numbers, a speaker 108 for broadcasting voice and messaging information and audible alerts, a microphone 110 for capturing and converting audible sounds to proportionate voltages, a light source 120 for visual indications, an antenna 112 for wirelessly communicating with a remote sender or receiver (not shown), a headphone jack 114, a battery charger jack 116, and input/output (IO) ports 118 for accessing the phone's internal circuitry for purposes such as inputting and outputting data.

The wireless device 100 interfaces with the provider equipment via a wireless communication link established with base stations. The wireless device 100, according the present example, works in conjunction with the provider equipment to provide a user with services such as telephone interconnect, short message service, dispatch or instant conferencing, circuit data, packet data, combinations thereof, as well as other data services.

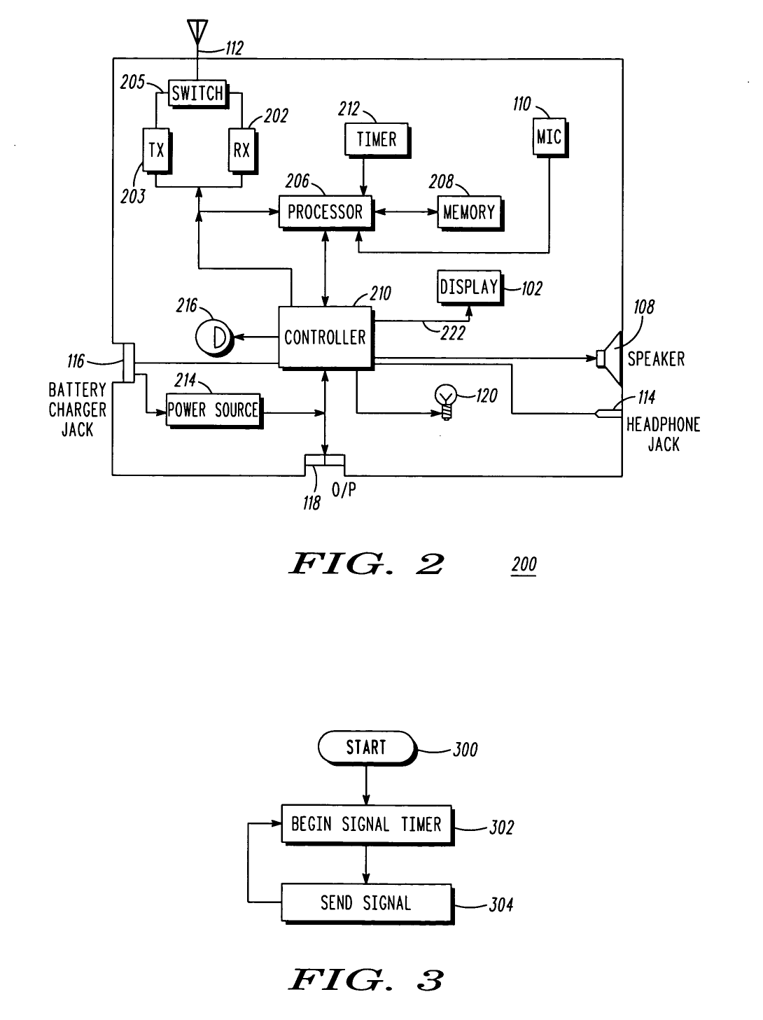

Referring now to FIG. 2, a block diagram of an electronic circuit 200 internal to the wireless device 100 is shown. The circuit 200 includes a transmitter 203 and a receiver 202. The transmitter 203 and receiver 202 are coupled via an antenna switch 205 to an antenna 112. For transmit operations, the antenna switch 205 couples the transmitter 203 to the antenna 112. Similarly, for receive operations, the antenna switch 205 couples the antenna 112 to the receiver 202. The transmitter 203 and receiver 202 are coupled to a processor 206.

Processors are well known in the art. The processor 206 is able to execute program instructions stored in a memory 208 and to store data received from receiver 202 and antenna 112 in memory 208. The processor 206 is also coupled to a controller 210, which selects between incoming-call notification modes in response to instructions provided from the processor 206. The processor 206 and controller 210 can be separate, discrete components or can be a single integrated unit. A timer module 212 provides timing information to the processor 206. The processor 206 utilizes the time information from the timer module 212 to keep track of scheduling or executing tasks. The wireless device 100 also includes a power source 214, such as a DC battery. The power source 214 is recharged by a battery charger attached to the battery charger jack 116. The controller 210 controls the battery charger jack 116 to prevent overcharging of the power source 214.

The circuit 200 outputs to a group of notification elements, shown in FIG. 1 as part of the overall user interface 100. The controller 210 controls and outputs signals to the notification elements when instructed to do so by the processor 206. The controller 210 outputs include an audible alert by sending an audible signal to the speaker 108; a visual alert by either sending information to the display 102 or a signal to light source 120; or outputting a signal on data output 118 or antenna 112. The controller 210 also is connected to a headphone jack 114. When a headphone is attached to the headphone jack 114, the controller does not send audio to the speaker 108.

The circuit 200 also includes an off-balanced motor 216. The controller 210 can produce a physical tactile stimulation to the user by turning the off-balanced motor 216. Other notification modes and signal interfaces not specifically shown in the figures, but that are well known to those of ordinary skill in the art, will work equally as well as those that are shown in FIGS. 1 and 2 and can be used in further embodiments of the present invention to achieve the same or similar results.

The particular notification mode selected, for example, can be a function of the identification of the source of the incoming message, including voice and/or data, can be a function of a selection made by a user of the wireless device 100, or any of several other possibilities. Additionally, the behavior/response of each mode to an incoming message or call by the particular alert can be personalized to each incoming message or call source by storing response data in memory 208, which is retrieved and executed by the processor 206 when an incoming message arrives. For example, a particular song can be played when a first incoming call number is recognized and a different song can be played when other incoming call numbers are recognized. In other modes, such as vibration mode, the number of vibration pulses or duration between pulses can be varied to indicate the source of the incoming call.

As can be seen in FIG. 2, in this example, each notification element is controlled by the controller 210. The controller 210 sends a signal along electrically conducive signal lines that couple the controller 210 and the individual notification elements, all shown in FIG. 2. The signal can consist of an increased voltage level, as used for the indicator light 120 or the off-balanced motor 216, an analog signal, as used to drive a speaker 208, a logic or digital signal, such as for a data interface, or any other signaling methods known in the art.

Looking at FIGS. 1 & 2 together, it should be clear that the electrical circuit 200 of FIG. 2 is housed inside of the wireless device 100 shown in FIG. 1. The exterior of the wireless device 100 has several electrical contacts 114 & 118 that are electrically coupled to outputs of the electrical circuit 200 and are accessible external to the electrical circuit 200. The outputs of electrical circuit 200 are indicated by arrows pointing away from the controller 210.

Because the controller 210 typically behaves in a predictable way-by placing signals on a designated signal line-one can easily tap into one of these signal lines and use the predictable electrical patterns for a bomb detonation trigger. For instance, the phone 100 can be configured so that its display 102 lights up to indicate an incoming call. By tapping into a signal line 222 coupling the controller 210 to the display 102, when the controller 210 intends to put a signal of a particular voltage level on the line to light up the display 102, it instead, or also, sends the signal to an external switch, which can be a trigger for an explosive device or other type of weapon or external catastrophic event. Even simpler to access are the external circuit-access points, such as the I/O port 118 and the jack 114.

However, if the phone were to introduce signals along all of its signal lines at random, unpredictable, or frequent periods that are not connected to a communication event, utilizing signal lines to detonate explosive devices or other types of weapons, or external catastrophic events, would no longer be feasible. One would never be able to predict when a bomb would explode because one would not be able to predict when a signal would be placed on a particular signal line by the wireless device 100. Or alternatively, if the signal were sent at predicable time intervals, but at a high frequency of occurrence, it would not be feasible to attach the wireless device 100 to a bomb or other explosive device trigger for fear that it would explode immediately or at an unplanned time. Therefore, even if one were able to predict the signal line signals, they would know that it would not be a reliable way to trigger a bomb or other explosive device or other type of weapon or external catastrophic event and would turn away from devices with this feature. The term “communication events” includes any function of a wireless device 100. A communication event does not require more than one user and includes events such as timer functions, calendar event reminders, and others.

In accordance with the above-mentioned principles, the present invention causes the controller 210 to periodically or randomly or unpredictably pulse each signal line within the device 100 to simulate an incoming call or some other user-scheduled event when, in fact, there is no incoming call or user scheduled event.

In one embodiment of the present invention, the processor 206 monitors timer 212 and pulses one or all signal lines coupling the controller 210 to the various notification elements within the device 100 at specified time intervals. Other electrically conductive paths within the circuit can be signaled as well. In other embodiments, the signal lines are pulsed sporadically in an unpredictable manner by a source either inside or outside the electrical circuit, which can include random intervals, occasional intervals, single pulses, and scattered occurrences of multiple pulses, or any combination thereof. The intervals between signal pulses vary according to a program residing in memory 208 and can vary between any value between zero and infinity. In addition, the pulses themselves can vary in duration and amplitude. These pulses are placed on the signal lines solely for the purpose of making a signal on the line unpredictable and are not related to any communication function of the wireless device 100, such as indicating an incoming call, logging an incoming call into a caller identification database within the device 100, or activating a notifying element. An electrical contact with any of these lines, whether internal or external to the housing of the wireless device, would not provide an electrical signal that can be predicted to occur in a certain pattern at a certain time to detonate an explosive device or trigger any external catastrophic event. Alternatively, the electrical contact with any of these lines may provide a signal with such frequency in pattern that would preclude use by another circuit or device external to the wireless device 100 to detonate the external device or trigger the catastrophic event.

Referring now to FIG. 3, there is provided a flow diagram illustrating an exemplary operation of the present invention. After initiating the operation in step 300, a signal timer begins counting in step 302. The signal timer can be programmed to cause the controller to send an energizing signal along a signal line at any interval of time, which can be varied by the processor in an unpredictable manner. The intervals may include occasionally, singly, in scattered instances, and even randomly. Once the timer reaches a signaling point, the process moves to step 304 where a signal is sent along a signal line. The flow then moves back up to step 302, where the timer starts again.

### CONCLUSION

The present invention can be realized in hardware, software, or a combination of hardware and software. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least a computer readable medium allowing a computer to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer to read such computer readable information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. An electrical circuit arrangement for deterring access to an electrical signal having a predictable electrical pattern, the circuit arrangement comprising:
an electronic circuit within a wireless device, the electronic circuit including a plurality of signal lines;
a processor for processing instructions; and
a controller communicatively coupled to the processor for sending at least one signal along each of the plurality of signal lines,
wherein the processor causes the controller to sporadically introduce a signal onto each of the plurality of signal lines, the signal being unrelated to any communication function or timed event of the wireless device.

2. The circuit arrangement according to claim 1, further comprising:
a timer coupled to the processor, the timer providing a clock pulse to the processor for determining a timing for causing the controller to introduce the signal onto each of the plurality of signal lines.

3. The circuit arrangement according to claim 1, wherein at least one of the plurality of signal lines couples the controller to a speaker, a display, a vibrator, a light source, an audio output port, or a data port.

4. The circuit arrangement according to claim 1, wherein the processor causes the controller to sporadically introduce the signal randomly, occasionally, singly, or in scattered instances introducing the signal onto each of the plurality of signal lines.

5. The circuit arrangement according to claim 1, wherein the signal comprises an increase in voltage level of the signal line.

6. The circuit arrangement according to claim 1, wherein a communication or timed event function includes receiving a call, receiving a message, notification of a scheduled event, providing a character or graphic on the display, or providing a notification of a timed event.

7. A wireless device for deterring access to an electrical signal of the device having a predictable electrical pattern, the wireless device comprising:
an electrical circuit within a wireless device, the electrical circuit having at least one electrical pathway; and
a controller, electrically coupled to the at least one electrical pathway, the controller providing a varying electrical signal that varies over time in a pattern that is unpredictable.

8. The wireless device according to claim 7, wherein the at least one electrical pathway couples the controller to a speaker, a display, a vibrator, a light source, a tone generator, an audio output port, or a data port.

9. The wireless device according to claim 7, wherein the at least one electrical pathway is electrically accessible at an output on an external surface of the wireless device.

10. The wireless device according to claim 7, further comprising:
at least one electrical contact that is electrically accessible, the electrical circuit including at least one output electrically coupled with the at least one electrical contact, wherein the controller is electrically coupled with the at least one output, the controller controlling the at least one output to provide a varying electrical signal at the at least one output, the varying electrical signal varying over time in a pattern that is unpredictable thereby providing an unpredictable varying electrical signal.

11. The wireless device according to claim 10, wherein the at least one output is a speaker, a display, a vibrator, a light source, a tone generator, an audio output port, or a data port.

12. A method for deterring access to an electrical signal of a wireless device having a predictable electrical pattern, the method comprising:
energizing an electrical circuit within a wireless device, the circuit having at least one electrical pathway that is electrically accessible and having a varying electrical signal that varies over time in a pattern that is unpredictable external to the electrical circuit.

13. The method according to claim 12, wherein the energizing is randomly, occasionally, singly, or in scattered instances.
